(19) United States
(12) Patent Application Publication
(10) Pub. No.: US 2010/0276527 A1
(43) Pub. Date: Nov. 4, 2010

(54) SPICE MILLS AND SHAKERS

(75) Inventors: Caroline Park, Seattle, WA (US); Ricky Wai Kit Chan, Seattle, WA (US); Sascha Kaposi, Tacoma, WA (US); Joanna Clark, Tacoma, WA (US)

Correspondence Address: BLACK LOWE & GRAHAM, PLLC, 701 FIFTH AVENUE, SUITE 4800, SEATTLE, WA, 98104, US

(73) Assignee: Progressive International Corporation, Kent, WA (US)

(21) Appl. No.: 12/769,420

(22) Filed: Apr. 28, 2010

Related U.S. Application Data
(60) Provisional application No. 61/173,891, filed on Apr. 29, 2009.

(51) Int. Cl. A47J 42/00

(52) U.S. Cl. 241/169.1

(57) ABSTRACT

A grinder includes an improved mechanism for adjusting the coarseness of the grind by providing a grind selector knob centrally located at the top of a cap. In some versions of the invention, the mill includes a base with a cavity for collecting the salt, spice, or pepper that is ground so that it can be measured within the base before dispensing. Ideally, the collector base includes an inclined floor and measurement indicators to enable the grinding and measuring of a desired volume of spice.

### PRIORITY CLAIM

This application claims the benefit of U.S. Provisional Application Ser. No. 61/173,891 filed Apr. 29, 2009; the contents of which are hereby incorporated by reference.

### FIELD OF THE INVENTION

This invention relates generally to devices for grinding and dispensing salt, pepper, and other spices.

### BACKGROUND OF THE INVENTION

There are a variety of salt, pepper, or spice shakers and mills presently available, but each of them has one or more shortcomings. The typical shakers include an internal cavity to store the salt or spice and an opening to allow the salt or spice to be dispensed. In the case of pepper or spices that are to be ground in a mill, the typical mill includes a grinding mechanism adjacent an opening through which the ground pepper or spice will fall.

In many cases, the peppermill retains some bits of ground pepper, allowing them to fall randomly on a table or countertop, creating a mess in the process. Many mills can also be very difficult to operate and to fill, and none provide a convenient way to grind a measured amount of pepper.

### SUMMARY OF THE INVENTION

The present inventions relate to several different embodiments of mills and shakers for salt, pepper, or other spices.

In accordance with some versions of the invention, a preferred grinder includes an improved mechanism for adjusting the coarseness of the grind by providing a grind selector knob centrally located at the top of a cap.

In some versions of the invention, the preferred mill includes a base with a cavity for collecting the salt, spice, or pepper that is ground so that it can be measured within the base before dispensing. Ideally, the collector base includes an inclined floor and measurement indicators to enable the grinding and measuring of a desired volume of spice.

In accordance with other versions of the invention, an improved grinding mechanism is incorporated into a spice mill. Preferably, the mechanism includes a pivotable handle that can be pivoted to extend radially outward from the mil to provide a larger radius and therefore greater leverage when grinding.

These and other examples of the invention will be described in further detail below.

### BRIEF DESCRIPTION OF THE DRAWINGS

Preferred and alternative examples of the present invention are described in detail below with reference to the following drawings:

FIG. 1 is a top perspective view of a preferred mill.

FIG. 2 is a side view of the mill of FIG. 1.

FIG. 3 is top view of the mill of FIG. 1.

FIG. 4 is a sectional view of the mill of FIG. 2, taken along line A-A.

FIG. 5 is a top perspective view of a cap of the mill of FIG. 1.

FIG. 6 is an exploded view of the mill of FIG. 1.

FIG. 7 is a side view of a measuring base for use with a preferred mill.

FIG. 8 is a sectional view of an alternate embodiment of a preferred mill.

FIG. 9 is a side view of an alternate embodiment of a preferred mill.

FIG. 10 is a sectional view of the mill of FIG. 9, taken along line B-B.

FIG. 11 is a perspective view of an alternate embodiment of a preferred mill.

FIG. 12 is a front view of the mill of FIG. 11.

FIG. 13 is a side view of the mill of FIG. 11.

FIG. 14 is a sectional view of the mill of FIG. 13, taken along line C-C.

FIG. 15 is a perspective view of a spice shaker, shown with a cap in a shake position.

FIG. 16 is a perspective view of the shaker of FIG. 15, shown with the cap in locked position.

FIG. 17 is a perspective view of the shaker of FIG. 15, shown with the cap in a pour position.

### DETAILED DESCRIPTION OF THE PREFERRED EMBODIMENT

A first version of a preferred peppermill 1 includes a rotatable cap 20 secured to a main body or housing 30. As discussed further below, in an exemplary mill the rotation of the cap with respect to the housing about a common central axis causes a corresponding rotation of internal grinding mechanisms in order to crush peppercorns stored within the housing. Although this description may refer to the device as a peppermill for simplicity, it should be understood that the inventions are also applicable for grinding salt and other spices. The use of the term “spice” should be understood to generically refer to salt, peppercorns, or other spices. Likewise, many of the inventive concepts may be incorporated into mills having different grinding mechanisms, including electronic or other grinding mechanisms that do not require physical rotation of two mill body components such as the cap 20 and housing 30 as used in a preferred version, but rather can include an internal motorized or other form of grinding or crushing mechanism.

In accordance with an example of the invention, the cap 20 includes a selector knob 10 centrally located at the top of the cap. The knob 10 includes a lower portion defining a shoulder that sits within a generally circular opening defined in the cap.

The knob is mounted on one end of a shaft 50. In the illustrated version, the knob comprises a main knob body 24, a disk 22, and a cover 23. Preferably the shaft is secured to the disk 22, either by press-fitting, gluing, or other means that attaches the shaft to the disk such that they rotate together. The disk 22 is received within a cavity formed within the main knob body 24, such that the disk 22 is sandwiched between the main knob body and the cover 23. The cavity within the main knob body is configured with an internal diameter that is greater than the outside diameter of the disk so that the disk 22 can freely rotate within the main knob body, and therefore within the knob. Accordingly, the shaft is held in place by the knob but freely rotates with respect to the selector knob 10. Likewise, the knob is secured in place axially at an end of the shaft but can freely rotate about the shaft.

The cap 20 includes a central hub 25 that is integrally formed with the cap. The central hub includes a channel formed at the center that creates a passageway through which the shaft is received. When the shaft is received within the passageway within the central hub, the cap 20 is pivotable about the axis defined by the shaft.

In one version as shown, an upper surface of the cap is formed as a concavity or a hemispherical well in which a first portion or side 26 of the upper surface of the cap is open to allow peppercorns or other spices to be poured through the opening to fill the mill and a second portion or side 16 of the well forms a continuous surface from the cap to the central hub. The channel or bore 28 provided within the central hub for receiving the shaft is preferably located and formed such that the central hub and shaft are securely fixed to one another. In one example, an upper end of the shaft includes a radial flange that fits within a corresponding recess in the central hub to affix the shaft within the hub for common rotational movement. Accordingly, rotation of the cap with respect to the main housing causes the shaft to rotate as well with respect to the housing.

At the opposite end of the shaft a generally conical grinding mechanism 60 is secured to the shaft in a fixed position. An upper surface of the grinding mechanism 60 mates with a grinding block 70, which is secured within the housing 30 in a fixed position. Because the cap, shaft, and grinding mechanism are all mounted together for common rotation about the axis defined by the shaft, each of these components will rotate together with respect to the housing 30 when the cap 20 is rotated. Likewise, because the grinding block 70 is fixedly secured within the housing, rotation of the cap 20 with respect to the housing 30 causes rotation of the grinding mechanism 60 with respect to the grinding block 70. Any peppercorns or other matter between these two components will be crushed, cracked, or ground accordingly, depending on the size of the gap between the two components.

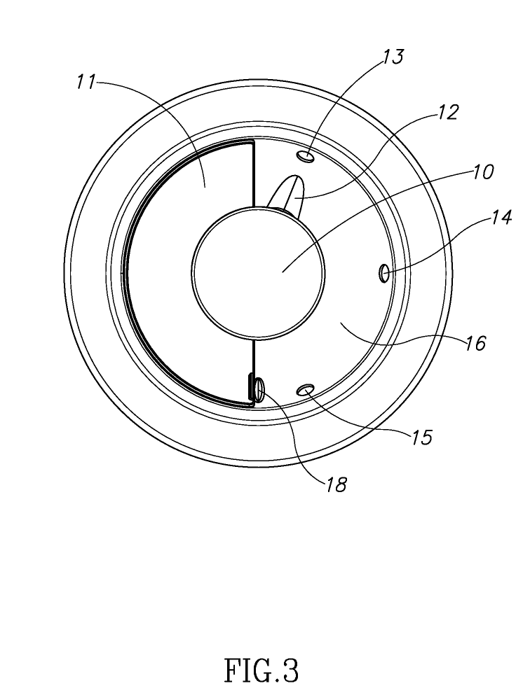

In one version of the invention, the size or coarseness of the grind is controlled by rotation of the knob 10. As best seen in the top view of FIG. 3, the knob 10 includes a pointer 12. Rotation of the knob 10 with respect to the cap causes the pointer to rotate such that it points toward one of several different coarseness indicators 13, 14, 15. In the version as shown, three different options are provided, nominally referred to as coarse, medium, and fine, respectively.

A lower surface of the knob 10 includes one or more feet 81, 82 that are configured to engage corresponding surfaces 83 provided within the cap 20. In one example of the invention, the surfaces 83 are provided at an interior location within the central hub. The surfaces 83 within the cap are stepped at different vertical heights as the surface proceeds about a central axis defined by the shaft. Thus, rotating the knob from a position in which the indicator points toward the coarse indicator 13 to the medium indicator 14 causes the knob to move such that the feet 81, 82 engage the middle step provided on the cap. This change in step urges the knob upward with respect to the top surface of the knob, and likewise urges the shaft in the same direction. At the same time, thus motion pulls the grinding mechanism 60 closer to the grinding block 70, narrowing the gap between these two components. Because they are closer together, any peppercorns will be ground more finely with the knob in this second position than in the first position in which it pointed toward the most coarse grind level. Rotation of the knob to the fine indicator 15 causes the knob to move to the highest step and urges the shaft upward even more, pulling the grinding mechanism 60 even closer to the grinding block 70, resulting in a fine grinding level. Although three discrete grinding levels are provided in the example shown and described, any number of levels are possible by adding additional or fewer steps as discussed above.

The cap further includes a rotatably sliding door 11 to allow the mill to be filled with peppercorns or other spices. At a top end of the cap 20, the inner cavity of the mill is generally sealed by two substantially semicircular pieces, including a lid 16 that is fixed in place and includes the coarseness markings as discussed above (and described as the solid portion of the hemispherical well in one version), and a rotatably sliding door 11 that can expose or cover the opening 26 formed in the cap. The first lid portion 16 may be integrally formed with the cap 20 or may be glued or otherwise secured to cover a portion of the cap. Though the lid portion 16 preferably is semicircular in shape, it may be larger or smaller to cover a greater or smaller portion of the top of the cap.

The sliding door is generally semicircular in shape and covers an opening at the top of the cap to allow peppercorns to be poured into the internal cavity within the mill. As shown, the sliding door 11 includes a central region that surrounds the base of the knob 10. A flange 18 extends upward from a surface of the sliding door 11 to allow the user to grasp the door and rotationally slide it into an open or a closed position, rotating it about the shaft 50.

Some versions of the invention may include a measuring base to capture a measured volume of ground pepper or other spice and then dispense it after the desired volume is achieved. In the example as shown, a measuring base 40 is secured to the housing 30 at the end opposite the cap 20. In general, the measuring base includes a bottom surface and sidewalls forming an internal cavity. The measuring base is secured to the housing in a position to catch the ground pepper or other spice as it emerges from the housing. Thus, as shown, the peppercorns are ground by the grinding mechanism 60 and grinding housing 70, allowing the ground bits of pepper to fall into the measuring base.

In the version as shown, the measuring base includes a ramp 43 forming a floor of the measuring base. The ramp forms an internal cavity having a small volume toward the bottom of the measuring base, thereby allowing for measurement of relatively small volumes such as ¼ teaspoon or the like within the base. Measurement indicators 46 are provided such that they are visible on the base 40, with the markings corresponding to volumes of pepper or other spice contained within the base.

The measuring base is removable from the housing, preferably in the form of a threaded engagement between the two sections. Thus, the measuring base includes external threads 42 and the lower portion of the housing includes mating internal threads 32. The two sections may be threaded oppositely, with internal threads on the base and external threads on the housing. Likewise, in other versions the pieces may be snap-fit, friction fitted, permanently secured, or integrally formed together.

The mill includes an opening 45 to allow ground pepper to fall without removing the measuring base 40, if desired. As shown, the opening 45 is formed in a top portion of the base, adjacent the top of the ramp 43, while in other versions the opening is formed in other locations to enable the spice to fall from the mill. Thus, when the mill is tipped toward the opening, ground spice can slide along the ramp and out the opening. This feature is useful even if the amount of ground spice is not being measured because it allows the user to control the application of the ground spice and prevents excess grindings from spilling out of the bottom of the mill except as desired. Likewise, the opening 45 and removability of the base allow a measured amount of ground spice to be either dispensed through the opening 45 or dispensed by removing the base 40 and then pouring the spice from the base.

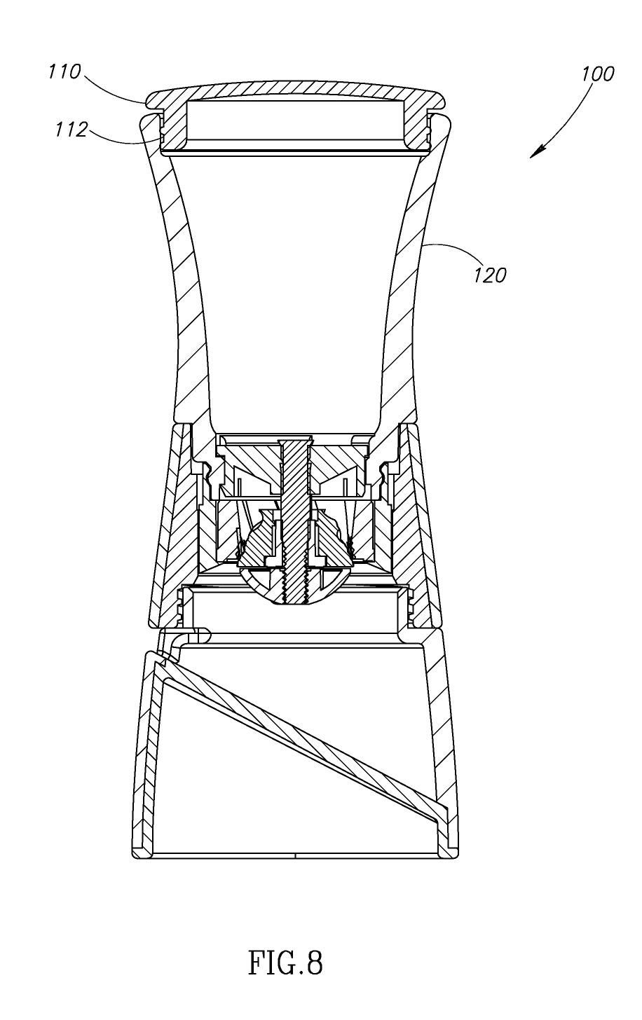

An alternate version of the spice mill 100 is shown in a sectional view in FIG. 8, and includes a lid 110 that secures to the cap 120. The lid includes external threads that mate with internal threads on the cap to secure the lid to the cap. Accordingly, this alternate version does not have an adjustment knob on the cap, and can be refilled by removing the lid to expose the inner cavity defined within the cap and housing. As described above, rotation of the cap with respect to the housing causes the grinding mechanism to rotate with respect to a grinding housing, thereby crushing peppercorns or other spices. A measuring base may also be included in this alternate version, as seen in FIG. 8.

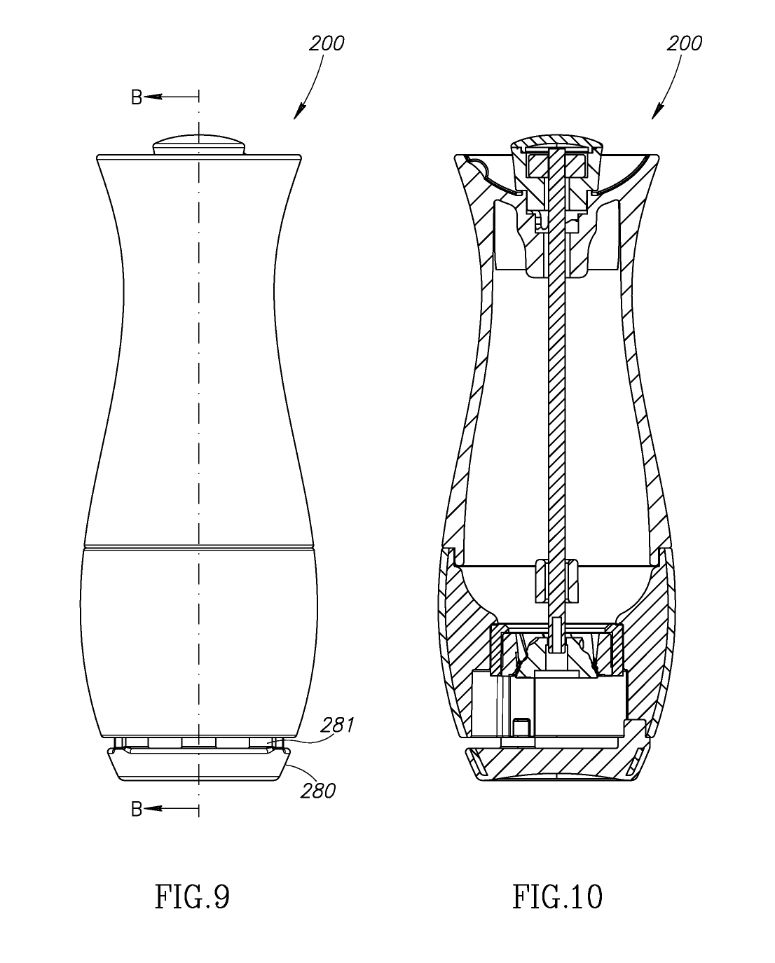

As shown in FIG. 9, a further alternate mill 200 includes a base tray 280 attached to the housing. The base tray includes a bottom and upwardly extending sidewalls to define an interior space that can catch ground spices. The base tray is preferably secured to the base by a tab and slot arrangement, in which several upwardly extending tabs 281 fit within corresponding slots within the base. The tabs and slots are configured to provide a frictional engagement such that the base tray can be selectively removed from or attached to the main body of the mill. Optionally, the length and depth of the tabs and slots can be configured such that the base tray can slide upward to substantially seal the space between the main body and the base tray, or can alternatively be positioned to leave a gap between the base tray and the main body. In other versions, the base tray may be threadably secured or otherwise affixed to the base.

As best seen in FIG. 9, the base tray defines several openings located circumferentially about the top of the base tray and between the upwardly extending tabs. The openings defined by the spaces between tabs and the gap between the top of the base tray and the bottom of the base allow for passages to allow ground spice to fall from the mill. At the same time, the base tray will catch ground pepper as it is ground, such that the ground pepper will only fall from the mill when the mill is tipped sufficiently to one side to allow the pepper to fall. When the mill is in an upright position as shown, the base tray will catch the ground spice to prevent it from leaking on a table or shelf.

If desired, the base tray can be fully removed during use to allow ground spice to freely fall from the mill as it is being used. Once the grinding is completed, the base tray can be secured to the mill to reduce the possibility of a mess caused by residual ground spice falling from the mill.

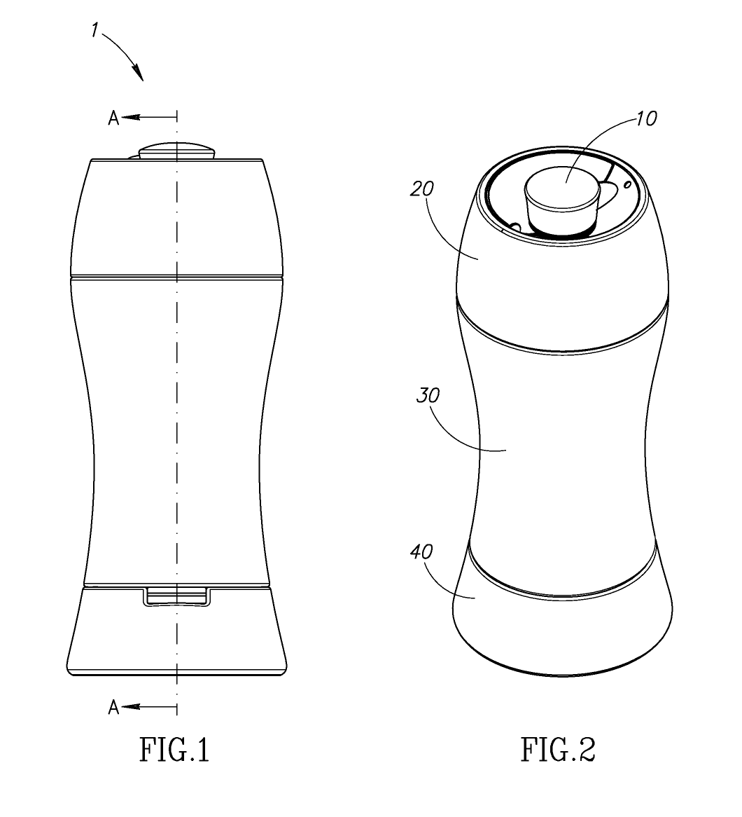

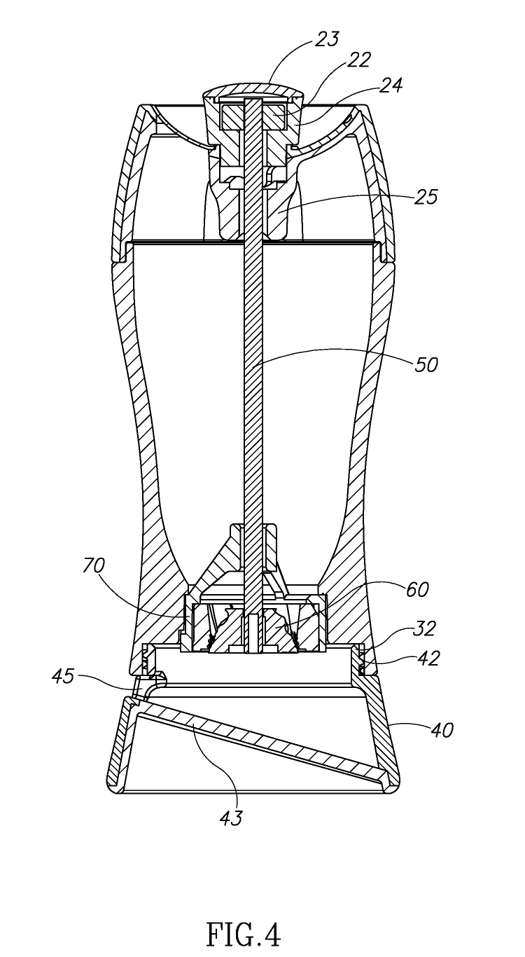

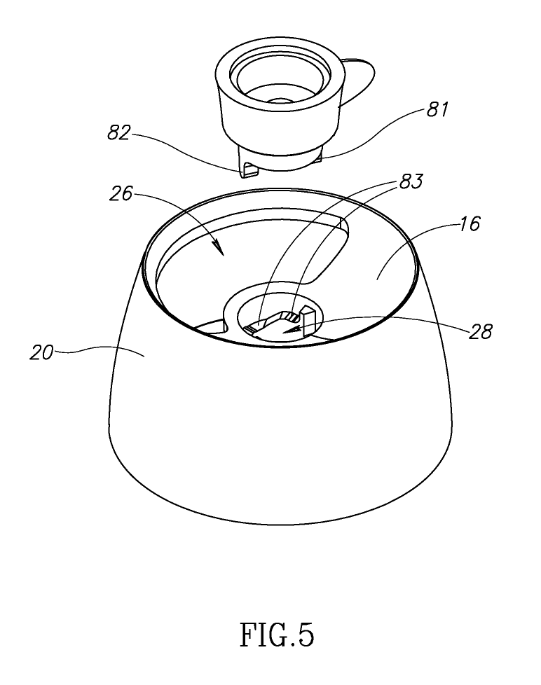

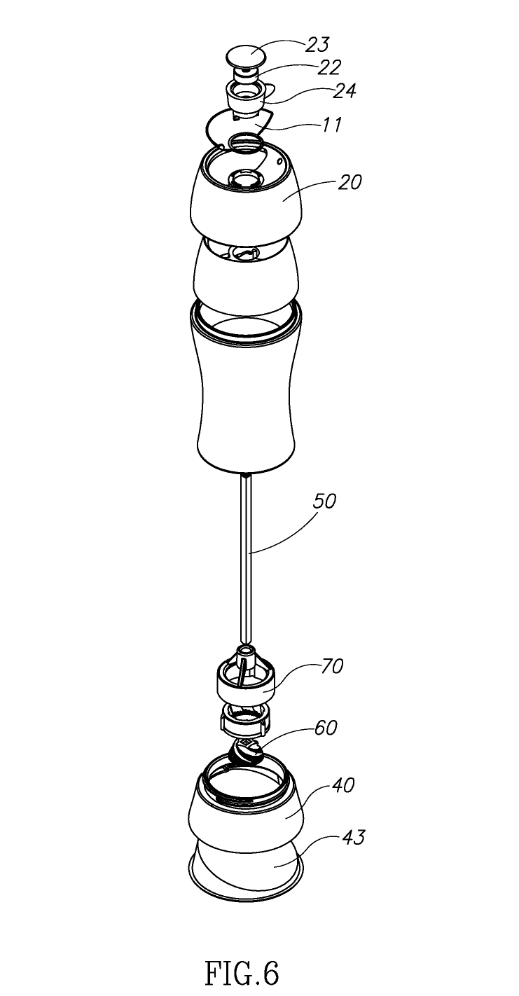

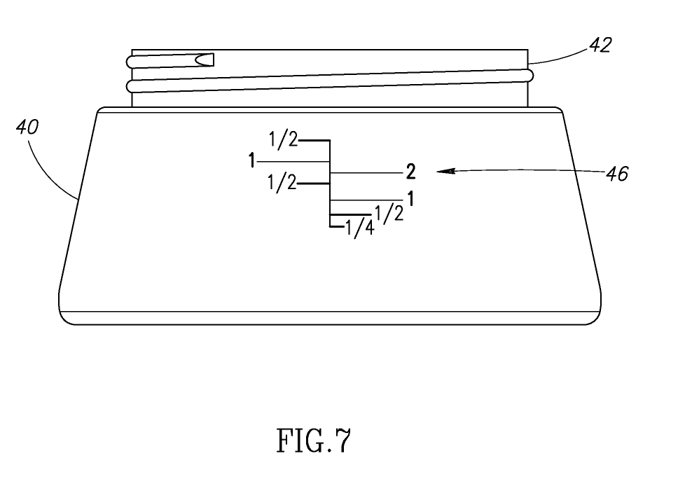

A version of the mill having the removable base tray may also include either the screw-top lid or the adjustment knob, as described above with respect to the embodiments illustrated in FIGS. 1-8. In a preferred version, it includes an adjustment knob having a pointer to allow for adjustment of grinding coarseness, as seen in FIG. 3. In addition, the version of FIGS. 9 and 10 may include a sliding refill door, generally consistent with the description above.

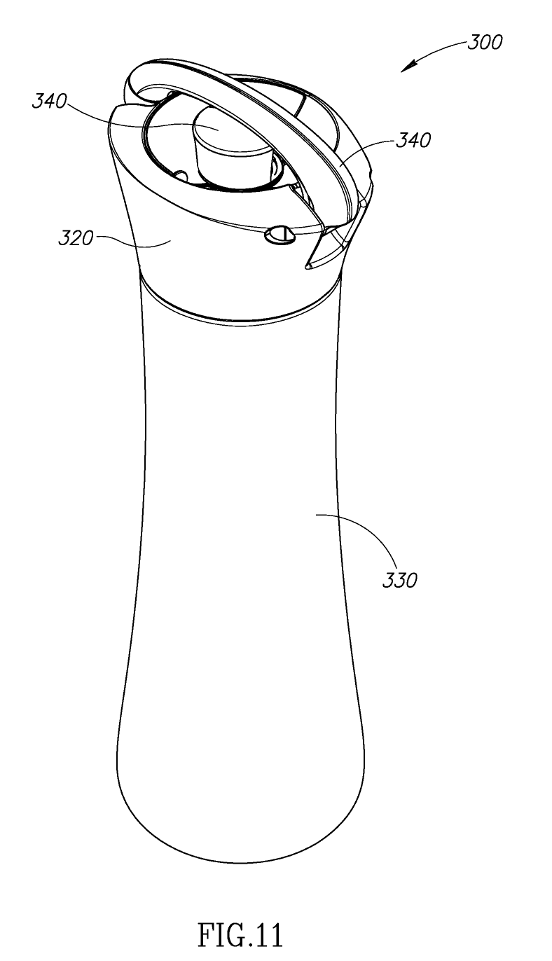

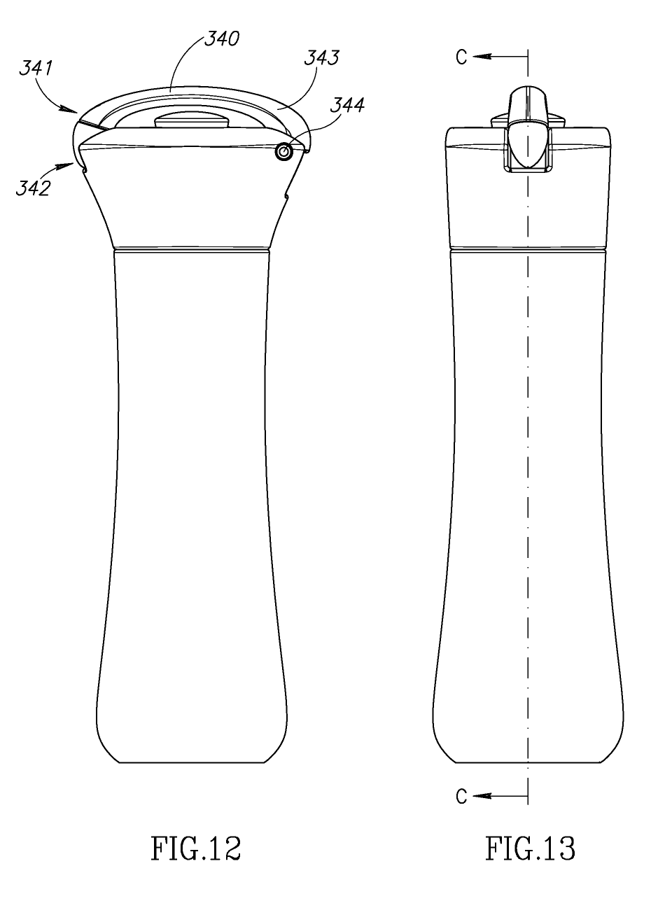

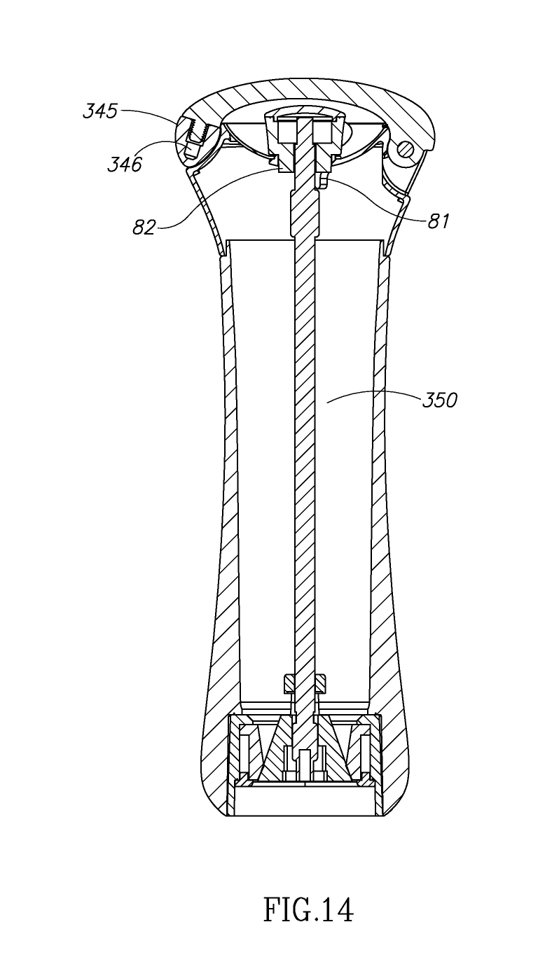

In yet another version of the invention as seen in FIGS. 11-14, a mill 300 includes a pivoting handle 340 secured to the cap 320 to aid in the rotation of the cap with respect to the housing 330 for grinding. In the version as shown, the handle spans the top of the mill diametrically across the cap. The illustrated handle forms an arc in order to clear the upper surface of the adjustment knob, though in other versions the knob is sufficiently recessed such that the handle may extend in a substantially straight path from one end to the opposite end.

A first end of the handle 343 is pivotally secured to the cap at a pivot point 344 while a second opposite end of the handle 341 rests in a slot 342 provided in the top of the cap. As noted above, the handle may have any shape, but in the version as shown the handle forms an arch to that it extends over and across the top of an adjustment knob of the type described above.

In use, the handle is pivoted outward, in a direction generally orthogonal to and extending radially away from the central axis of the mill as defined by the shaft 350. Thus, the handle pivots about the pivot point 344 to extend the second end of the handle to a position that is radially outward from the shaft and pivot point. Rotation of the cap with respect to the housing causes rotation of the grinding mechanism as described above. With the handle extended outwardly, the cap can be easier to rotate by the improved leverage provided by the handle. When grinding is finished, the handle is pivoted back in place such that the second end of the handle is received in the slot.

The second end of the handle may further include a grip 345. In some versions the grip is an over-molded non-skid material such as rubber or silicone. In other versions the grip is rotatably secured to a tip 346 of the handle such that the grip 345 rotates on the tip, allowing the user to grasp the grip for use in rotating the cap with respect to the housing. When not in use, the handle can be stowed with the second end resting in the slot 342. As shown, the tip points downward when the handle is stowed, but will point upward, generally in a direction from the base toward the cap, such that the tip is accessible from the top end of the mill.

Although the handle is shown as spanning diametrically across the top of the mill, it may alternatively be configured so that the stowed position is along a side of the cap or the mill generally. In a straight-sided mill, the stowed position may be one that is generally parallel to the shaft.

It should be understood that the handle feature as described above may be used in conjunction with any or all of the other spice mill features, including the knob adjustment, the measuring base, and the sliding refill door, for example.

Yet another alternate spice shaker 400 is shown in the illustrations, in this case preferably in the form of a salt or spice shaker rather than a mill. The shaker 400 includes a shaker body 420 having a pivoting ball cap 410. The cap 410 is received within an upper surface of the shaker, and mounted for pivotal movement. The pivoting ball cap includes a plurality of shaker holes 412 on a first surface of the cap, a larger pour opening 414 at a second surface of the cap, and a grip 413 at an intermediate location between the shaker holes and the pour opening.

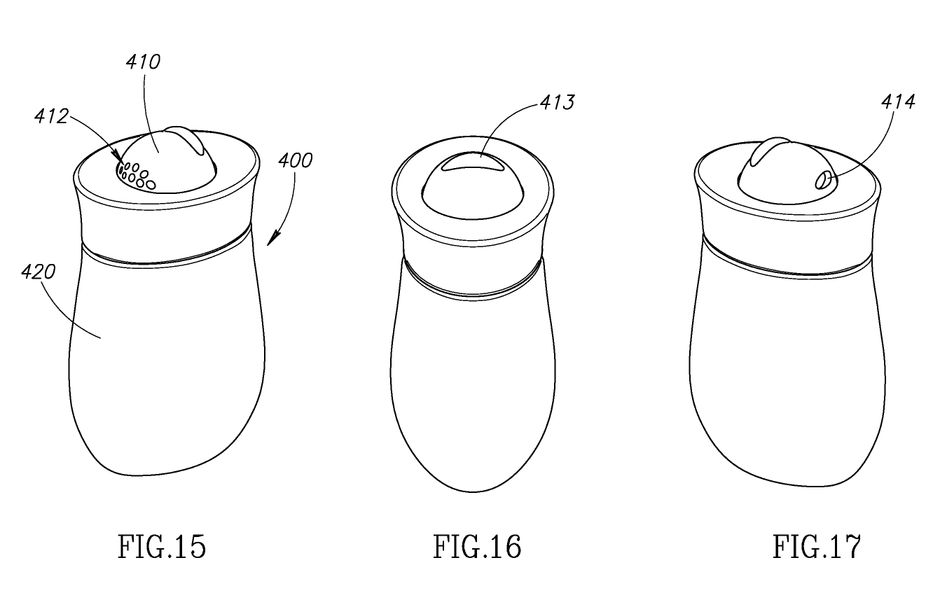

The pivoting ball cap is pivotable to three positions, including a first position in which the ball cap is rotated to expose the shaker holes but the pour opening is rotated to a level below the top of the shaker. The cap is pivoted to this position in FIG. 15, with the grip moved to a position adjacent one end of the top of the shaker and the plurality of shaker holes 412 exposed above the top of the shaker to allow salt or other spice to exit the shaker through the holes 412.

At a second position, as seen in FIG. 17, the ball cap is rotated such that the shaker holes are rotated below the top surface of the shaker but the pour opening 414 is exposed.

Finally, at a third position, illustrated in FIG. 16, both the pour opening and the shaker holes are rotated to be below the top of the cap so that no salt or other spice can spill from the shaker. In order to achieve this configuration, the pour opening and shaker holes must be positioned on the ball cap such that they are below the upper surface of the cap when the grip is in this central position.

As shown in the preferred version, the grip is at an intermediate location between the shaker holes and the pour opening. In other versions the openings may be oriented differently while still allowing for multiple shaking or pouring abilities.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A spice mill, comprising:
a main body having an outer surface and defining an interior cavity;
a cap carried on the main body, the cap and main body being rotatable with respect to one another about a central axis;
a shaft extending through the main body, the shaft having a first end adjacent the cap and an opposing second end;
a grinding mechanism attached to the shaft, the grinding mechanism having an outer surface spaced apart from a grinding block to define a gap between the grinding mechanism and the grinding block, the grinding mechanism further being configured and positioned to rotate with the shaft in order to crush spices that fall within the gap; and
a knob secured to the first end of the shaft, the knob having a lower surface extending toward the cap and an upper surface extending axially away from the cap, the lower surface of the knob engaging an upper support surface carried on the cap, the knob and shaft being rotatable between at least a first position and a second position, wherein the engagement of the upper support surface with the lower surface of the knob causes the knob to be axially farther outward from the cap when the knob is at the second position with respect to the position of the knob at the first position, thereby causing the gap to be relatively smaller when the knob is at the second position than when the knob is at the first position.

2. The spice mill of claim 1, wherein the knob is rotatable to at least a third position, wherein the engagement of the upper support surface with the lower surface of the knob causes the knob to be axially farther outward from the cap when the knob is at the third position with respect to the position of the knob at the second position, thereby causing the gap to be relatively smaller when the knob is at the third position than when the knob is at the second position.

3. The spice mill of claim 2, wherein the lower surface of the knob further comprises at least one foot and the upper support surface comprises a plurality of steps, whereby rotation of the knob causes the at least one foot to engage a different one of the plurality of steps.

4. The spice mill of claim 3, wherein the cap further comprises an opening to enable the spice to be inserted through the opening and into the spice mill.

5. The spice mill of claim 4, wherein the opening is formed on an upper surface of the cap, the cap further comprising a door positioned on the cap for rotational movement to selectively open and close the opening.

6. The spice mill of claim 3, wherein the cap further comprises a central bore, and further wherein the at least one foot extends through the central bore.

7. A spice mill, comprising:
a mill body defining an interior cavity for housing a spice;
a grinding mechanism and a grinding block attached within the interior cavity of the mill body and positioned with respect to one another to crush spices that are positioned between the grinding mechanism and the grinding block; and
a base defined on one end of the mill body, the base having a floor and upwardly extending sidewalls to define an interior space, the base having a lower surface defining a plane for resting the mill on a horizontal surface, at least a portion of the floor of the base being inclined with respect to the plane.

8. The mill of claim 7, wherein the floor is inclined continuously from a first location to a diametrically opposite second location.

9. The mill of claim 8, further comprising an opening formed in the base.

10. The mill of claim 9, wherein the opening is formed adjacent the second location.

11. The mill of claim 10, wherein the base is removably attached to the mill.

12. The mill of claim 10, further comprising volumetric markings formed on the upwardly extending sidewalls substantially above the first location.

13. A spice mill, comprising:
a main body having an outer surface and defining an interior cavity;
a cap carried on the main body, the cap and main body being rotatable with respect to one another about a central axis;
a grinding mechanism and a grinding block each supported within the interior cavity, the grinding mechanism being spaced apart from the grinding block to define a gap between the grinding mechanism and the grinding block, the grinding mechanism and the grinding block further being configured and positioned to rotate with respect to one another when the cap is rotated with respect to the main body in order to crush spices that fall within the gap; and
a handle having a first end and a second end, the second end pivotally mounted to the cap, the handle being movable between a stowed position and an operable position, the first end of the handle in the operable position extending substantially radially outward from the mill;
wherein a first radius between the central axis and the first end of the handle in the operable position is greater than a second radius between the central axis and the second end of the handle.

14. The mill of claim 13, wherein the first end of the handle further comprises a grip rotatably mounted to the first end of the handle.

15. The mill of claim 13, further comprising a slot formed in the cap, the slot receiving at least a portion of the first end of the handle in the stowed position.

16. The mill of claim 13, further comprising a shaft extending through the main body, the shaft having a first end adjacent the cap and an opposing second end, the grinding mechanism being attached to the shaft.

17. The mill of claim 16, further comprising a knob secured to the first end of the shaft, the knob having a lower surface extending toward the cap and an upper surface extending axially away from the cap, the lower surface of the knob engaging an upper support surface carried on the cap, the knob and shaft being rotatable between at least a first position and a second position, wherein the engagement of the upper support surface with the lower surface of the knob causes the knob to be axially farther outward from the cap when the knob is at the second position with respect to the position of the knob at the first position, thereby causing the gap to be relatively smaller when the knob is at the second position than when the knob is at the first position
